(19) United States
(12) Patent Application Publication
(10) Pub. No.: US 2016/0136579 A1
(43) Pub. Date: May 19, 2016

(54) MINOR COMPONENT RATIO BALANCING IN FILTRATION SYSTEMS, AND ASSOCIATED METHODS

(71) Applicant: Massachusetts Institute of Technology, Cambridge, MA (US)

(72) Inventors: Ronan K. McGovern, Cambridge, MA (US); John H. Lienhard, V, Lexington, MA (US)

(73) Assignee: Massachusetts Institute of Technology, Cambridge, MA (US)

(21) Appl. No.: 14/943,881

(22) Filed: Nov. 17, 2015

Related U.S. Application Data
(60) Provisional application No. 62/080,727, filed on Nov. 17, 2014.

(51) Int. Cl. B01D 61/14; B01D 61/02

(52) U.S. Cl. CPC B01D 61/145; B01D 61/025; B01D 61/027; B01D 2313/08

(57) ABSTRACT

Filtration systems in which the ratios of minor components in mixtures can be balanced, and associated methods, are generally described. Certain embodiments are related to methods in which a portion of a retentate stream produced by filtering an initial liquid feed during a first filtration step is mixed with the permeate produced by filtering the permeate from the first filtration step. In some cases, the amount of the first retentate that is mixed with the second permeate is selected such that the ratios of the minor components within the final retentate and permeate streams produced by the filtration system are similar to the ratio of the minor components within the initial liquid. By maintaining similar ratios of minor components, according to certain embodiments, the flavor profile of the initial liquid mixture can be substantially maintained in the concentrated and diluted streams produced by the filtration system.

### RELATED APPLICATIONS

This application claims priority under 35 U.S.C. §119(e) to U.S. Provisional Patent Application Ser. No. 62/080,727, filed Nov. 17, 2014 and entitled “Minor Component Ratio Balancing in Filtration Systems, and Associated Methods,” which is incorporated herein by reference in its entirety for all purposes.

### TECHNICAL FIELD

Filtration systems and associated methods are generally described.

### BACKGROUND

Separation of components within an initial mixture is a common task performed in a number of industries. Filtration is one method that can be used to perform such separations. Filtration systems have been employed in which an inlet stream containing a mixture of two or more components is transported over a filtration medium to produce a first stream transported through the filter (generally referred to as a permeate stream, which is enriched in the component that is more readily transported through the filtration medium) and a second stream that is not transported through the filter (generally referred to as a retentate stream, which is enriched in the component that is less readily transported through the filtration medium).

It can be challenging, in some instances, to achieve effective separation of components within an initial mixture using filtration systems. For example, one challenge faced in the beer industry is effectively using filtration-based systems to concentrate beer, as ethanol is generally less effectively filtered from water than dissolved salts. In addition, current commercial processes for concentrating such mixtures are generally inefficient from both an energy and capital cost standpoint.

Improved systems and methods for performing filtration are therefore desirable.

### SUMMARY

Filtration systems in which the ratios of minor components in mixtures are balanced, and associated methods, are generally described. Certain embodiments are related to methods in which a portion of a retentate stream produced by filtering an initial liquid feed during a first filtration step is mixed with the permeate produced by filtering the permeate from the first filtration step. The subject matter of the present invention involves, in some cases, interrelated products, alternative solutions to a particular problem, and/or a plurality of different uses of one or more systems and/or articles.

According to certain embodiments, a method of concentrating a minor component of a liquid feed is provided. The method comprises, according to certain embodiments, establishing a hydraulic pressure differential across a filtration medium within a first filter receiving a liquid feed comprising a major component and the minor component to produce a first permeate enriched in the major component relative to the liquid feed and a first retentate enriched in the minor component relative to the liquid feed; establishing a hydraulic pressure differential across a filtration medium within a second filter receiving at least a portion of the first permeate to produce a second permeate enriched in the major component relative to the first permeate and a second retentate enriched in the minor component relative to the first permeate; mixing a first portion of the first retentate with at least a portion of the second permeate; and mixing a second portion of the first retentate with at least a portion of the second retentate.

In some embodiments, a filtration system is provided. The filtration system comprises, according to certain embodiments, a first filter comprising a first filtration medium defining a permeate side and a retentate side of the first filter; a second filter comprising a second filtration medium defining a permeate side and a retentate side of the second filter; a fluidic pathway connecting the permeate side of the first filter to the retentate side of the second filter; a fluidic pathway connecting the retentate side of the first filter to the retentate side of the second filter; and a fluidic pathway connecting the retentate side of the first filter to the permeate side of the second filter.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 is an exemplary schematic illustration of a filter, which may be used in association with certain embodiments described herein; and

FIG. 2 is, according to certain embodiments, a schematic illustration of a filtration system.

### DETAILED DESCRIPTION

Filtration systems in which the ratios of minor components in mixtures are balanced, and associated methods, are generally described. Certain embodiments are related to methods in which a portion of a retentate stream produced by filtering an initial liquid feed during a first filtration step is mixed with the permeate produced by filtering the permeate from the first filtration step. In some such embodiments, the amount of the first retentate that is mixed with the second permeate is selected such that the ratios of the minor components within the final retentate and permeate streams produced by the filtration system are similar to the ratio of the minor components within the initial liquid. By maintaining similar ratios of minor components, according to certain embodiments, the flavor profile of the initial liquid mixture can be substantially maintained in the concentrated and diluted streams produced by the filtration system.

Certain of the embodiments described herein can be used in filtration systems and/or methods in which the filtration medium is permeable to multiple components in the inlet mixture. As one non-limiting example, reverse osmosis membranes are typically at least partially permeable to ethanol, in addition to water. Accordingly, in some such cases, when mixtures comprising water and ethanol are processed using reverse osmosis systems, both ethanol and water are transported through the reverse osmosis membrane, leading to incomplete separation of the ethanol from the permeate water. This behavior is in contrast to the behavior typically observed in reverse osmosis systems in which dissolved salts are separated from solvents (e.g., water), in which substantially complete separation between permeate water and dissolved salt is often achieved. Incomplete filtration of ethanol from water can lead to challenges in producing concentrates of ethanol-containing mixtures (e.g., beer, wine, liquor, and the like) that have the same ratio of ethanol to other minor components within the initial mixture, as the ethanol will generally be transported through the filtration medium while other minor components will not be substantially transported through the filtration medium. Certain, although not necessarily all, of the embodiments described herein can be advantageously employed in certain such systems to correct for minor component ratio imbalances that may arise due to the difference in the rates at which the minor components of an initial liquid feed are transported through the filtration medium, as described in more detail below.

Certain embodiments involve using filters to concentrate a minor component of a liquid feed comprising at least one minor component and a major component. The term “major component” is generally used herein to describe the most abundant component—by weight percentage (wt %)—of a mixture within a liquid feed. “Minor components” are all components of the mixture that are not the major component.

In some embodiments, there is a single minor component in the mixture of the liquid feed. For example, in a mixture that is 60 wt % water and 40 wt % ethanol, water would be the major component and ethanol would be the (single) minor component.

In other embodiments, multiple minor components may be present in the mixture of the liquid feed. For example, in a mixture that is 45 wt % water, 30 wt % ethanol, and 25 wt % methanol, water would be the major component, and ethanol and methanol would both be minor components. As another example, in a mixture that is 91.4 wt % water, 8 wt % ethanol, and 0.6 wt % protein, water would be the major component, and ethanol and protein would both be minor components.

According to certain embodiments, the liquid feed can contain a “target minor component.” Generally, the target minor component corresponds to the minor component within the liquid feed that the filtration system is configured to concentrate. In liquid feeds containing only a major component and a minor component, the target minor component is—by default—the single minor component. In cases where the feed stream comprises multiple minor components, any of the minor components can be the target component. In certain embodiments, the target minor component corresponds to the second most abundant component in the liquid feed, by weight percentage (which corresponds to the most abundant of the minor components in the liquid feed, by weight percentage). For example, in some embodiments, the liquid feed comprises water as the major component, ethanol as the most abundant minor component, and an additional minor component that is less abundant than ethanol, and the target minor component is ethanol.

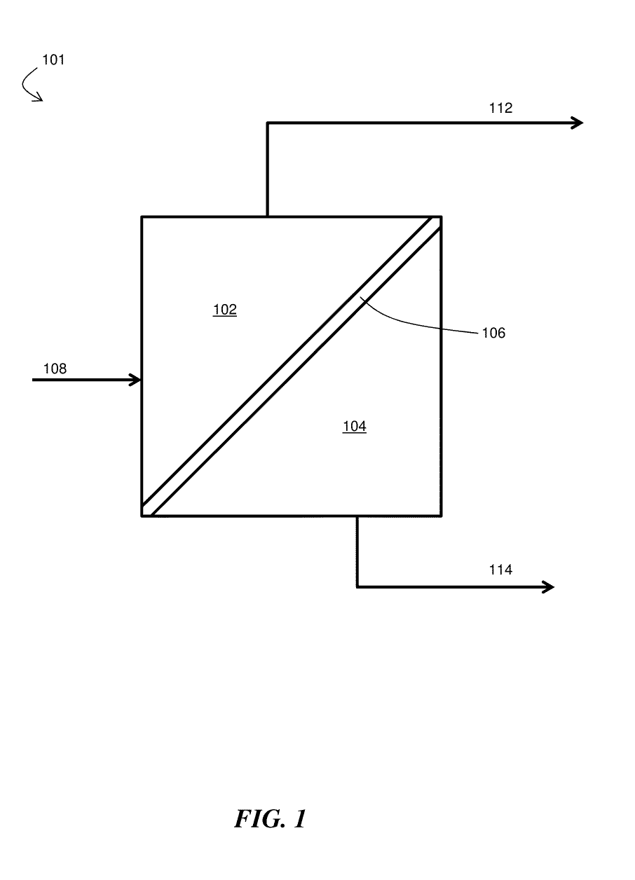

As described in more detail below, a variety of suitable filters can be used in association with the systems and methods described herein. FIG. 1 is a cross-sectional schematic illustration of an exemplary filter 101, which can be used in association with certain of the embodiments described herein. Filter 101 comprises filtration medium 106. The filtration medium can define a permeate side and a retentate side of the filter. For example, in FIG. 1, filtration medium 106 separates filter 101 into retentate side 102 (to which the incoming liquid feed is transported) and permeate side 104. The filtration medium can allow at least one component of an incoming liquid feed (which can contain a mixture of a major component and at least one minor component) to pass through the filtration medium to a larger extent that at least one other component of the incoming liquid mixture.

During operation, a hydraulic pressure differential can be established across the filtration medium within the filter. The hydraulic pressure differential can be established across the filtration medium such that the gauge pressure on the retentate side of the filter (P_{R}) exceeds the gauge pressure on the permeate side of the filter (P_{P}). In some cases, a hydraulic pressure differential can be established across the filtration medium by applying a positive pressure to the retentate side of the filter. For example, referring to FIG. 1, a hydraulic pressure differential can be established across filtration medium 106 by applying a positive pressure to retentate side 102 of filter 101. The positive pressure can be applied, for example, using a pump, a pressurized gas stream, or any other suitable pressurization device. In some cases, a hydraulic pressure differential can be established across the filtration medium by applying a negative pressure to the permeate side of the filter. Referring to FIG. 1, for example, a hydraulic pressure differential can be established across filtration medium 106 by applying a negative pressure to permeate side 104 of filter 101. The negative pressure can be applied, for example, by drawing a vacuum on the permeate side of the filter. In some cases, the applied hydraulic pressure differential within the filter can vary spatially. In some such embodiments, the applied hydraulic pressure differential within the filter is uniform within 5 bar.

Establishing a hydraulic pressure differential across the filtration medium can produce a first permeate enriched in the major component relative to the liquid feed and a first retentate enriched in at least one minor component (e.g., the target minor component) relative to the liquid feed. For example, in FIG. 1, a liquid feed containing a major component and at least one minor component (e.g., the target minor component) can be transported to filter 101 via liquid feed 108. In certain embodiments, a hydraulic pressure differential is established across filtration medium 106 such that the hydraulic pressure decreases from retentate side 102 of filter 101 to permeate side 104 of filter 101. The established hydraulic pressure differential across the filtration medium (ΔP_{E}) can be expressed as:

ΔP_{E}=P_{R}−P_{P}

where P_{R} is the gauge pressure on the retentate side of the filter and P_{P} is the gauge pressure on the permeate side of the filter.

Generally, the liquid mixtures in the filter will each have an osmotic pressure associated with them. For example, the liquid on the retentate side of the filter will generally have an osmotic pressure π_{R}, and the liquid of the permeate side of the filter will generally have an osmotic pressure π_{P}. Accordingly, the osmotic pressure differential across the filtration medium (Δπ) can be expressed as:

Δπ=π_{R}−π_{P}

In certain embodiments, when the established hydraulic pressure differential across the filtration medium exceeds the osmotic pressure differential across the filtration medium, one or more components of the liquid feed (e.g., the major component and, in some cases, a portion of the minor component(s)) is transported across the filtration medium. Such behavior is known to those familiar with the phenomenon of reverse osmosis.

In practice, the filtration methods, according to certain embodiments, can proceed by supplying a liquid mixture that is relatively dilute in the minor component(s) to retentate side 102 of filter 101. Retentate side 102 of filter 101 can be pressurized to a pressure (P_{R}) sufficiently in excess of the pressure (P_{P}) on permeate side 104 of filter 101 to force at least a portion of the major component through filtration medium 106 while retaining a sufficient amount of the minor component(s) on retentate side 102 such that the concentration of the minor component(s) on retentate side 102 of filter 101 increases above the concentration of the minor component(s) within liquid feed 108. In FIG. 1, for example, establishing the hydraulic pressure differential across filtration medium 106 can produce first permeate 114 enriched in the major component relative to liquid feed 108 and first retentate 112 enriched in a minor component (e.g., the target minor component) relative to liquid feed 108. The filtration process can be continued until a desired concentration of the minor component(s) is achieved.

In many traditional pressure-based filtration systems (such as reverse osmosis systems), the transport of minor components through the filtration medium is limited such that a high degree of separation is achieved between the major component and the minor component(s) of the liquid mixture fed to the filter. Such systems are said to achieve high rejection levels of the minor component(s). The rejection level of a particular filtration medium with respect to a particular minor component can be expressed as a percentage (also referred to herein as a “rejection percentage,” described in more detail below).

While filtration media of many salt-based filtration systems are capable of achieving high rejection percentages during operation, filtration media of filtration systems used to concentrate other types of minor components frequently cannot achieve such high rejection percentages. For example, when non-charged, low molecular weight compounds such as ethanol are used as minor components, rejection percentages can be quite low. Thus, relatively large amounts of such minor components can be transported—along with the major component—through the filtration medium during operation. The transport of relatively large amounts of minor component(s) through the filtration medium can make it difficult to maintain ratios of minor components in the filter product streams that are similar to the ratio of the minor components within the initial liquid feed.

As one particular example, when beer (which includes a mixture of water, ethanol, and proteins) is filtered, a relatively large amount of ethanol may be transported through the filtration medium (along with water), while a relatively low amount of proteins may be transported through the filtration medium. In such cases, the ratio of ethanol to protein in the retentate will be lower than the ratio of ethanol to protein in the permeate, and thus, the retentate and permeate will have substantially different flavor profiles than the originally-fed beer.

Certain embodiments of the present invention are related to the recognition that a portion of a retentate stream from an upstream filter may be mixed with a permeate stream from a downstream filter to produce a final mixture having a ratio of minor components that is similar to the ratio of the minor components in the initial liquid fed to the upstream filter. Certain embodiments are related to the recognition that, by mixing only a portion of a retentate stream from an upstream filter with a retentate from a downstream filter, one can produce a mixed retentate stream having a ratio of minor components that is similar to the ratio of the minor components in the initial liquid fed to the upstream filter. In addition, in some embodiments, mixing a first portion of the retentate produced by the upstream filter with the permeate produced by the downstream filter to produce a mixed permeate stream and mixing a second portion of the retentate produced by the upstream filter with the retentate produced by the downstream filter to produce a mixed retentate stream can result in similar ratios of minor components in the mixed retentate stream and the mixed permeate stream.

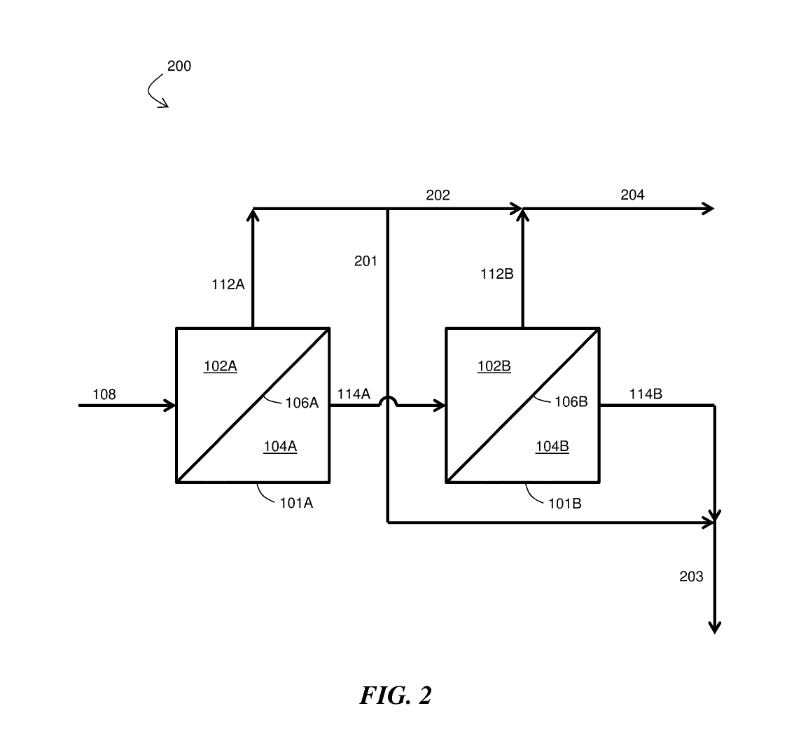

As noted above, certain embodiments are related to filtration systems, which can be used for concentrating minor components of a mixture. FIG. 2 is a schematic illustration of one such exemplary filtration system 200.

In some embodiments, the filtration system comprises a first filter comprising a first filtration medium defining a permeate side and a retentate side of the first filter. For example, in the exemplary embodiment of FIG. 2, first filter 101A can comprise first filtration medium 106A which can define permeate side 104A and retentate side 102A of first filter 101A. In the exemplary embodiment of FIG. 2, retentate side 102A of first filter 101A is fluidically connected to feed stream 108. Feed stream 108 can contain a liquid mixture including a major component and one or more minor components (one of which may be a target minor component).

According to certain embodiments, the filtration system comprises a second filter comprising a second filtration medium defining a permeate side and a retentate side of the second filter. For example, in the exemplary embodiment of FIG. 2, filtration system 200 comprises second filter 101B comprising second filtration medium 106B defining permeate side 104B and retentate side 102B of filter 101B.

In some embodiments, the filtration system comprises a fluidic pathway connecting the permeate side of the first filter to the retentate side of the second filter. In FIG. 2, for example, stream 114A establishes a fluidic pathway connecting permeate side 104A of first filter 101A to retentate side 102B of second filter 101B. As illustrated in FIG. 2, first filter 101A is upstream of second filter 101B (and, thus, second filter 101B is downstream of filter 101A).

The filtration system can also comprise, according to certain embodiments, a fluidic pathway connecting the retentate side of the first filter to the retentate side of the second filter. For example, in the exemplary embodiment of FIG. 2, stream 112B, stream 112A, and stream 202 are fluidically connected and establish a fluidic connection between retentate side 102A of filter 101A and retentate side 102B of filter 101B. The filtration system can also comprise, according to some embodiments, a fluidic pathway connecting the retentate side of the first filter to the permeate side of the second filter. For example, in the exemplary embodiment of FIG. 2, streams 112A, 201 and 114B are fluidically connected and establish a fluidic connection between retentate side 102A of first filter 101A and permeate side 104B of second filter 101B. According to certain embodiments, establishing fluidic connections between the retentate side of the first filter and the retentate side of the second filter and between the retentate side of the first filter and the permeate side of the second filter can allow one to produce two mixtures with minor component ratios that are similar to each other and/or similar to the original liquid inlet, as described in more detail below.

In some embodiments, the first filter and the second filter are directly fluidically connected. For example, in FIG. 2, first filter 101A and second filter 101B are directly fluidically connected via stream 114A. While direct fluidic connections are illustrated in the exemplary embodiment of FIG. 2, it should be understood that indirect fluidic connections are also possible. Accordingly, in some embodiments, the permeate side of the first filter and the retentate side of the second filter can be directly fluidically connected, for example, such that no filters are fluidically connected between the permeate side of the first filter and the retentate side of the second filter. In other embodiments, the first and second filters can be indirectly fluidically connected, for example, such that one or more intermediate filters is fluidically connected between the permeate side of the first filter and the retentate side of the second filter.

Fluidic connections between filters can be made using any suitable connector (e.g., piping, tubing, hoses, and the like). In certain embodiments, fluidic connections between filters can be made using enclosed conduit capable of withstanding hydraulic pressures applied to the fluids within the conduits without substantially leaking.

The filtration system may comprise, in some embodiments, a fluidic pathway configured to receive a mixture of at least a portion of the first retentate and at least a portion of the second retentate. For example, referring back to FIG. 2, system 200 comprises stream 204, which is configured to receive the portion of first retentate 112A that is transported through stream 202 as well as second retentate 112B. In some embodiments, the mixture of the first retentate portion and the second retentate portion can form a final concentrated product of the filtration system. For example, stream 204 in FIG. 2 may, according to certain embodiments, contain the final concentrated product of filtration system 200.

In some embodiments, the filtration system comprises a fluidic pathway configured to receive a mixture of at least a portion of the first retentate and at least a portion of the second permeate. For example, referring back to FIG. 2, system 200 comprises stream 203, which is configured to receive the portion of first retentate 112A that is transported through stream 201 as well as second permeate 114B. In some embodiments, the mixture of the first retentate portion and the second permeate portion can also form a final product of the filtration system. The mixture of the first retentate portion and the second permeate portion can, in some embodiments, form a product that is diluted in the minor component(s) relative to the liquid feed stream but is configured for commercial sale. Referring to FIG. 2, for example, stream 203 may form a final product that is diluted in the minor component(s) contained within feed stream 108, relative to feed stream 108, but that is configured for commercial sale.

In some embodiments, where single filters are described herein, the single filter can be replaced with multiple filters fluidically connected in parallel. For example, referring to FIG. 2, filter 101A and/or filter 101B may, according to certain embodiments, be replaced with multiple filters fluidically connected in parallel.

Exemplary inventive filtration systems for concentrating minor components of the liquid feed can be operated as follows. Some embodiments comprise establishing a hydraulic pressure differential across a filtration medium within a first filter receiving a liquid feed comprising a major component and the minor component to produce a first permeate enriched in the major component relative to the liquid feed and a first retentate enriched in the minor component relative to the liquid feed. For example, referring to the exemplary embodiment of FIG. 2, liquid feed stream 108 can be transported to first filter 101A. A hydraulic pressure differential can be established across filtration medium 106A of first filter 101A. Establishing the hydraulic pressure differential across filtration medium 106A can result in at least a portion of the major component being transported across filtration medium 106A. Accordingly, in some such embodiments, establishing the hydraulic pressure differential across filtration medium 106A can produce permeate 114A which is enriched in the major component relative to liquid feed 108. In addition, establishing the hydraulic pressure differential across filtration medium 106A can produce retentate 112A which is enriched in a minor component (e.g., the target minor component) relative to liquid feed 108.

Certain embodiments comprise establishing a hydraulic pressure differential across a filtration medium within a second filter receiving at least a portion (e.g., at least about 10 wt %, at least about 25 wt %, at least about 50 wt %, at least about 75 wt %, at least about 90 wt %, at least about 95 wt %, at least about 99 wt %, or all) of the first permeate to produce a second permeate enriched in the major component relative to the first permeate and a second retentate enriched in the minor component relative to the first permeate. For example, in the exemplary embodiment of FIG. 2, at least a portion (or, in some embodiments, all) of permeate 114A from first filter 101A can be transported to retentate side 102B of second filter 101B. A hydraulic pressure differential can be established across filtration medium 106B of second filter 101B. Establishing the hydraulic pressure differential across filtration medium 106B can result in at least a portion of the major component being transported across filtration medium 106B. Accordingly, in some such embodiments, establishing a hydraulic pressure differential across filtration medium 106B can produce second permeate 114B which is enriched in the major component relative to first permeate 114A. In addition, establishing the hydraulic pressure differential across filtration medium 106B can produce second retentate 112B which is enriched in a minor component (e.g., the target minor component) relative to first permeate 114A.

According to certain embodiments, the liquid feed comprises more than one minor component. For example, in FIG. 2, liquid feed 108 can comprise a first minor component and a second minor component. As one specific example, liquid feed 108 could comprise water as the major component, ethanol as a first minor component (e.g., the target minor component), and protein as a second minor component.

In some embodiments in which the liquid feed comprises multiple minor components, establishing a hydraulic pressure differential across the filtration medium within the first filter receiving the liquid feed produces a first retentate enriched in both the first minor component and the second minor component relative to the liquid feed. For example, referring to the exemplary embodiment of FIG. 2, in some embodiments, after a hydraulic pressure differential is applied across filtration medium 106A of first filter 101A, retentate stream 112A can be relatively enriched in the first and second minor components relative to liquid feed 108.

In some embodiments in which the liquid feed comprises multiple minor components, the first minor component and the second minor component can be transported across the first filtration medium of the first filter at different rates. For example, when ethanol and protein are the minor components, ethanol may be transported across filtration medium 106A to a greater degree than protein is transported across filtration medium 106A. Accordingly, in some such embodiments, the ratio of the first minor component to the second minor component within the first retentate (e.g., stream 112A in FIG. 2) may be substantially different than the ratio of the first minor component to the second minor component within the liquid feed (e.g., stream 108 in

FIG. 2). In addition, the ratio of the first minor component to the second minor component within the first permeate (e.g., stream 114A in FIG. 2) may be substantially different than the ratio of the first minor component to the second minor component within the liquid feed (e.g., stream 108 in FIG. 2). The ratio of the first minor component to the second minor component within the first retentate (e.g., stream 112A in FIG. 2) may, in some cases, be substantially different than the ratio of the first minor component to the second minor component within the first permeate (e.g., stream 114A in FIG. 2).

In some embodiments, during at least a portion of the time during which the hydraulic pressure differential is established across the first filtration medium, the flux of a first minor component (e.g., the target minor component) through the first filtration medium may be at least about 1.5 times, at least about 2 times, at least about 3 times, at least about 5 times, at least about 10 times, at least about 50 times, or at least about 100 times (and/or, in certain embodiments, up to about 10⁵ times, up to about 10⁶ times, or more) the flux of a second minor component through the first filtration medium.

In certain embodiments, the first filtration medium can have different rejection percentages with respect to a first minor component (e.g., the target minor component) and a second minor component. For example, in some embodiments, the first filtration medium has a first rejection percentage, by weight, with respect to a first minor component (e.g., the target minor component), and the first filtration medium has a second rejection percentage, by weight, with respect to the second minor component. In some such embodiments, the smaller of the first rejection percentage and the second rejection percentage is less than about 0.95, less than about 0.9, less than about 0.75, less than about 0.5, less than about 0.25, less than about 0.1, less than about 0.01, or less than about 0.001 of the larger of the first rejection percentage and the second rejection percentage.

As an exemplary illustration of the above-described comparison, the first filtration medium could have a rejection percentage of 80% with respect to the first minor component and a rejection percentage of 99% with respect to the second minor component. In such a case, the smaller of the first rejection percentage and the second rejection percentage would be 80% (corresponding to the rejection percentage of the first minor component), and the larger of the first rejection percentage and the second rejection percentage would be 99% (corresponding to the rejection percentage of the second minor component). In this case, the smaller of the first rejection percentage and the second rejection percentage (80%) is 0.808 times the larger of the first rejection percentage and the second rejection percentage (99%) (i.e., 80% is 0.808 times 99%).

In certain embodiments in which the liquid feed comprises multiple minor components, establishing a hydraulic pressure differential across the filtration medium within the second filter receiving at least a portion of the first permeate produces a second retentate enriched in both the first minor component and the second minor component relative to the first permeate. For example, referring to the exemplary embodiment of FIG. 2, in some embodiments, after a hydraulic pressure is established across filtration medium 106B of second filter 101B, retentate stream 112B can be enriched in the first and second minor components relative to first permeate 114A.

In some embodiments in which the liquid feed comprises multiple minor components, the first minor component and the second minor component can be transported across the filtration medium of the second filter at different rates. For example, when ethanol and protein are the minor components, ethanol may be transported across filtration medium 106B to a greater degree than protein is transported across filtration medium 106B. Accordingly, in some such embodiments, the ratio of the first minor component to the second minor component within the second retentate (e.g., stream 112B in FIG. 2) may be substantially different than the ratio of the first minor component to the second minor component within the first permeate (e.g., stream 114A in FIG. 2). In addition, the ratio of the first minor component to the second minor component within the second permeate (e.g., stream 114B in FIG. 2) may be substantially different than the ratio of the first minor component to the second minor component within the first permeate (e.g., stream 114A in FIG. 2). The ratio of the first minor component to the second minor component within the second retentate (e.g., stream 112B in FIG. 2) may, in some cases, be substantially different than the ratio of the first minor component to the second minor component within the second permeate (e.g., stream 114B in FIG. 2).

In some embodiments, during at least a portion of the time during which the hydraulic pressure differential is established across the second filtration medium, the flux of a first minor component (e.g., the target minor component) through the second filtration medium may be at least about 1.5 times, at least about 2 times, at least about 3 times, at least about 5 times, at least about 10 times, at least about 50 times, or at least about 100 times (and/or, in certain embodiments, up to about 10⁵ times, up to about 10⁶ times, or more) the flux of a second minor component through the second filtration medium.

In certain embodiments, the second filtration medium can have different rejection percentages with respect to a first minor component (e.g., the target minor component) and a second minor component. For example, in some embodiments, the second filtration medium has a first rejection percentage, by weight, with respect to a first minor component (e.g., the target minor component), and the second filtration medium has a second rejection percentage, by weight, with respect to the second minor component. In some such embodiments, the smaller of the first rejection percentage and the second rejection percentage is less than about 0.95, less than about 0.9, less than about 0.75, less than about 0.5, less than about 0.25, less than about 0.1, less than about 0.01, or less than about 0.001 of the larger of the first rejection percentage and the second rejection percentage.

Transportation of the minor components at different rates across the filtration media can result in the production of retentate and/or permeate streams with substantially different ratios of first and second minor components.

In some embodiments, the difference between the ratio of the weight percentage of the first minor component (e.g., the target minor component) to the weight percentage of the second minor component within the first retentate (e.g., the ratio within stream 112A of FIG. 2) and the ratio of the weight percentage of the first minor component to the weight percentage of the second minor component within the first permeate (e.g., the ratio within stream 114A of FIG. 2) is at least about 5%, at least about 10%, at least about 25%, or at least about 50%.

In some embodiments, the difference between the ratio of the weight percentage of the first minor component to the weight percentage of the second minor component within the second retentate (e.g., the ratio within stream 112B in FIG. 2) and the ratio of the weight percentage of the first minor component to the weight percentage of the second minor component within the second permeate (e.g., the ratio within stream 114B in FIG. 2) is at least about 5%, at least about 10%, at least about 25%, or at least about 50%.

In some embodiments, the difference between the ratio of the weight percentage of the first minor component to the weight percentage of the second minor component within the first retentate (e.g., the ratio within stream 112A in FIG. 2) and the ratio of the weight percentage of the first minor component to the weight percentage of the second minor component within the second permeate (e.g., the ratio within stream 114B in FIG. 2) is at least about 5%, at least about 10%, at least about 25%, or at least about 50%.

Some embodiments comprise mixing a first portion of the first retentate with at least a portion (or all) of the second permeate. Mixing the first portion of the first retentate with at least a portion of the second permeate can produce a first mixture. For example, referring to FIG. 2, a first portion of retentate 112A can be transported via pathway 201 and mixed with at least a portion (or all) of second permeate 114B to form first mixture 203. Mixing the first portion of retentate 112A with at least a portion of second permeate 114B can allow one, according to certain embodiments, to balance the ratio of minor components within mixed stream 203 with the ratio of minor components in feed stream 108 (and, in some embodiments, with the ratio of minor components in mixed stream 204). In some embodiments, at least about 1 wt %, at least about 5 wt %, at least about 10 wt %, or at least about 20 wt % (and/or, in some embodiments, up to 40 wt %, up to 50 wt %, up to 60 wt %, up to 70 wt %, up to 90 wt %, or more) of the first retentate is mixed with at least a portion (or all) of the second permeate.

Certain embodiments comprise mixing a second portion of the first retentate with at least a portion of the second retentate. Mixing the second portion of the first retentate with at least a portion of the second retentate can produce a second mixture. For example, referring to FIG. 2, a second portion of retentate 112A can be transported via pathway 202 and mixed with at least a portion (or all) of second retentate 112B to form second mixture 204. Mixing the second portion of retentate 112A with at least a portion of second retentate 112B can allow one, according to certain embodiments, to balance the ratio of minor components within mixed stream 204 with the ratio of minor components in feed stream 108 (and, in some embodiments, with the ratio of minor components in mixed stream 203). In some embodiments, at least about 1 wt %, at least about 5 wt %, at least about 10 wt %, at least about 20 wt %, at least about 30 wt %, at least about 40 wt %, or at least about 50 wt % (and/or, in some embodiments, up to 40 wt %, up to 50 wt %, up to 60 wt %, up to 70 wt %, up to 90 wt %, up to 95 wt %, up to 99 wt %, or more) of the first retentate is mixed with at least a portion (or all) of the second retentate.

As noted elsewhere herein, certain aspects relate to the ability to produce product streams in which the ratios of at least a portion of the minor components are relatively close to each other. For example, in some embodiments, the difference between the ratio of the weight percentage of a first minor component to the weight percentage of a second minor component within the first mixture (e.g., the ratio within stream 203 of FIG. 2) and the ratio of the weight percentage of the first minor component to the weight percentage of the second minor component within the second mixture (e.g., the ratio within stream 204 of FIG. 2) is less than about 20%, less than about 10%, less than about 5%, or less than about 1%. In certain embodiments, the difference between the ratio of the weight percentage of the target minor component to the weight percentage of a second minor component within the first mixture (e.g., the ratio within stream 203 of FIG. 2) and the ratio of the weight percentage of the target minor component to the weight percentage of the second minor component within the second mixture (e.g., the ratio within stream 204 of FIG. 2) is less than about 20%, less than about 10%, less than about 5%, or less than about 1%. In some such embodiments, the target minor component can be the most abundant minor component in the initial liquid feed stream, such as feed stream 108 of filtration system 200.

The ratio (R_{w}) of a weight percentage of first minor component (wt₁) to the weight percentage of a second minor component (wt₂) in a mixture can be expressed in decimal form, calculated as follows:

$${R}_{w} = \frac{{wt}_{1}}{{wt}_{2}}$$

For example, if a first minor component is present at 5 wt %, and a second minor component is present at 2 wt %, the ratio of the weight percentage of the first minor component to the weight percentage of the second minor component would be 2.5.

The difference between a first weight percentage ratio of a first minor component to a second minor component in a first stream (R_{w1}) and a second weight percentage ratio between the first minor component to the second minor component in a second stream (R_{w2}) is calculated as a percentage difference, relative to the larger of the two ratios. For example, if is larger than R_{w2}, the difference (R_{diff}) between R_{w1} and R_{w2} would be calculated as:

$${R}_{diff} = \frac{{R}_{w 1} - {R}_{w 2}}{{R}_{w 1}} \times 100 \%$$

If, on the other hand, R_{w1} is smaller than R_{w2}, the difference (R_{diff}) between R_{w1} and R_{w2} would be calculated as:

$${R}_{diff} = \frac{{R}_{w 2} - {R}_{w 1}}{{R}_{w 2}} \times 100 \%$$

As an exemplary illustration of the above-described comparison, a first mixture could include 3 wt % ethanol and 1 wt % protein, thus having a ratio of the weight percentage of the ethanol to the weight percentage of the protein of 3 (because 3 divided by 1 is 3). A second mixture could include 0.25 wt % ethanol and 0.5 wt % protein, thus having a ratio of the weight percentage of the ethanol to the weight percentage of the protein of 0.5 (because 0.25 divided by 0.5 is 0.5). The difference between the first weight percentage ratio between ethanol and protein in the first stream and the second weight percentage ratio between ethanol and protein in the second stream would be 83.3%, calculated as:

$$\begin{matrix}{R}_{diff} = \frac{{R}_{w 1} - {R}_{w 2}}{{R}_{w 1}} \times 100 \% \\ = \frac{3 - 0.5}{3} \times 100 \% \\ = 83.3 \%\end{matrix}$$

In this example, the first mixture also has a ratio of the weight percentage of the protein to the weight percentage of the ethanol of 0.33 (because 1 divided by 3 is 0.33), and the second mixture has a ratio of the weight percentage of the protein to the weight percentage of the ethanol of 2 (because 0.5 divided by 0.25 is 2). The difference between the first weight percentage ratio between protein and ethanol in the first stream and the second weight percentage ratio between protein and ethanol in the second stream would be 75%, calculated as:

$$\begin{matrix}{R}_{diff} = \frac{{R}_{w 1} - {R}_{w 2}}{{R}_{w 1}} \times 100 \% \\ = \frac{2 - 0.333}{2} \times 100 \% \\ = 83.3 \%\end{matrix}$$

According to certain embodiments, the difference between the ratio of the weight percentage of a first minor component to the weight percentage of a second minor component within the first mixture (e.g., the ratio within stream 203 of FIG. 2) and the ratio of the weight percentage of the first minor component to the weight percentage of the second minor component within the liquid feed (e.g., the ratio within stream 108 of FIG. 2) is less than about 20%, less than about 10%, less than about 5%, or less than about 1%. In certain embodiments, the difference between the ratio of the weight percentage of the target minor component to the weight percentage of a second minor component within the first mixture (e.g., the ratio within stream 203 of FIG. 2) and the ratio of the weight percentage of the target minor component to the weight percentage of the second minor component within the liquid feed (e.g., the ratio within stream 108 of FIG. 2) is less than about 20%, less than about 10%, less than about 5%, or less than about 1%. In some such embodiments, the target minor component can be the most abundant minor component in the initial liquid feed stream, such as feed stream 108 of filtration system 200.

In some embodiments, the difference between the ratio of the weight percentage of a first minor component to the weight percentage of the second minor component within the second mixture (e.g., the ratio within stream 204 of FIG. 2) and the ratio of the weight percentage of the first minor component to the weight percentage of the second minor component within the liquid feed (e.g., the ratio within stream 108 of FIG. 2) is less than about 20%, less than about 10%, less than about 5%, or less than about 1%. In certain embodiments, the difference between the ratio of the weight percentage of the target minor component to the weight percentage of a second minor component within the second mixture (e.g., the ratio within stream 204 of FIG. 2) and the ratio of the weight percentage of the target minor component to the weight percentage of the second minor component within the liquid feed (e.g., the ratio within stream 108 of FIG. 2) is less than about 20%, less than about 10%, less than about 5%, or less than about 1%. In some such embodiments, the target minor component can be the most abundant minor component in the initial liquid feed stream, such as feed stream 108 of filtration system 200.

Certain of the systems and methods described herein can be used to concentrate one or more minor components within a variety of types of liquid feeds (e.g., liquid mixtures fed to the system, for example, via stream 108 in FIGS. 1-2).

The liquid feed can comprise a number of suitable major components. In certain embodiments, the major component is a liquid. For example, the major component can be a consumable liquid. According to certain embodiments, the major component is non-ionic (i.e., the major component does not have a net ionic charge). The major component can have a molecular weight of less than about 150 g/mol, less than about 100 g/mol, less than about 50 g/mol, or less than 25 g/mol, according to some embodiments. For example, in some embodiments, the major component is water. In some embodiments, the major component can be a solvent.

The liquid feed can contain a number of suitable minor components. As noted above, certain liquid feed mixtures can include exactly one minor component while other mixtures may contain more than one minor component. In certain embodiments, at least one (or all) of the minor components (e.g., the target minor component) is a liquid. For example, at least one (or all) of the minor components (e.g., the target minor component) can be a consumable liquid. According to certain embodiments, at least one (or all) of the minor components (e.g., the target minor component) is non-ionic (i.e., the minor component does not have a net ionic charge). According to some embodiments, at least one (or all) of the minor components (e.g., the target minor component) can have a molecular weight of less than about 150 g/mol, less than about 100 g/mol, or less than about 50 g/mol (and/or, in some embodiments, at least about 25 g/mol, at least about 35 g/mol, or at least about 40 g/mol). In some embodiments, at least one of the minor components is an alcohol, such as ethanol. In some embodiments, at least one of the minor components is a protein. In some embodiments, at least one of the minor components is a sugar, such as glucose. In some embodiments, at least one of the minor components is a salt.

In some embodiments, the target minor component is a co-solvent with the major component. For example, in some embodiments, ethanol can act as a co-solvent with water, for example, dissolving one or more salts within the liquid feed. In other embodiments, the target minor component does not act as a solvent.

According to certain embodiments, the liquid feed containing the major component in the minor component(s) can be a consumable mixture. In some embodiments, the liquid feed is an aqueous mixture. In some embodiments, the liquid feed comprises water as the major component and ethanol as a minor component (e.g., the target minor component). In some embodiments in which water and ethanol are components of the liquid feed, the liquid feed can further comprise one or more proteins. According to certain embodiments, the liquid feed is an alcoholic beverage, such as beer, wine, and the like. In some, but not necessarily all, cases the systems and methods described herein can be particularly advantageous in producing concentrates of beer.

In certain embodiments, the concentration of at least one minor component (e.g., the target minor component) in the liquid feed is relatively high. For example, in certain embodiments, the concentration of a minor component (e.g., the target minor component) in the liquid feed (e.g., in stream 108 of FIGS. 1-2) is at least about 0.001% by weight, at least about 0.01% by weight, at least about 0.1% by weight, or at least about 1% by weight (and/or, in certain embodiments, up to about 5% by weight, up to about 10% by weight, up to about 15% by weight, up to about 20% by weight, or more). Such relatively high concentrations of a minor component(s) can be observed, for example, in systems for the concentration of alcoholic beverages (e.g., beer, wine, and the like). The use of high minor component concentrations is not required, however, and in some embodiments, the concentration of a minor component (e.g., the target minor component) in the liquid feed can be as low as 0.0001% by weight, as low as 0.00001% by weight, or lower.

According to certain embodiments, the minor component(s) (e.g., the target minor component) is a component that is not highly rejected by traditional filtration media, such as reverse osmosis membranes, nanofiltration membranes, and/or ultrafiltration membranes. Thus, in some embodiments, the rejection percentage (the calculation of which for particular minor components is described below) of one or more filtration media with respect to a minor component (e.g., the target minor component) can be relatively low. According to certain embodiments, the rejection percentage of the minor component (e.g., the target minor component) with respect to a filtration medium within a filter of the filtration system is between about 10% and about 95%, between about 35% and about 90%, or between about 60% and about 90%. In some embodiments, the rejection percentage of the minor component (e.g., the target minor component) with respect to a filtration medium within a filter of the filtration system is between about 10% and about 99% or between about 95% and about 99%. For example, in some embodiments, the rejection percentage of the minor component (e.g., the target minor component) with respect to the first filtration medium of the first filter of the filtration system (e.g., filtration medium 106 of filter 101 of FIG. 1 or filter 101A of FIG. 2) is between about 10% and about 99%, between about 10% and about 95%, between about 35% and about 90%, or between about 60% and about 90%. In certain embodiments, the rejection percentage of the minor component (e.g., the target minor component) with respect to the second filtration medium of the second filter of the filtration system (e.g., filtration medium 106B of filter 101B of FIG. 2) is between about 10% and about 99%, between about 10% and about 95%, between about 35% and about 90%, or between about 60% and about 90%.

The rejection percentage of a filtration medium with respect to a particular minor component is generally calculated by dividing the weight percentage of the minor component within the permeate stream by the weight percentage of the minor component within the liquid feed stream, and multiplying by 100%, when the filter is operated at steady state. When determining the rejection percentage of a filtration medium with respect to a minor component, the filtration medium should be arranged as a single spiral wound membrane element that is 8 inches in diameter and 40 inches in length. The filtration medium should contain 30 mil thick feed channel spacers to produce an active membrane area that is 400 square feet. The permeate flow rate should be equal to 10% of the feed flow rate. In addition, the feed stream should include only the minor component whose rejection percentage is being determined and the major component, with the concentration by of the minor component at a level such that the osmotic pressure of the feed stream is 26 bar. In addition, the feed stream should be set at a temperature of 25 degrees Celsius, have a pH of 7, and be fed to the filter at a pressure of 800 psi gauge.

In some cases, the osmotic pressure differential across the filtration medium (Δπ) can vary substantially from the osmotic pressure of the feed, for example, if minor components contained within the feed stream are not well rejected by the filtration medium.

In cases in which the osmotic pressure differential varies from the osmotic pressure of the feed, it may be desirable to achieve a substantially continuous rate of major component transfer across the filtration medium. However, if the hydraulic pressure on the retentate side is not adjusted to account for variations in the osmotic pressure differential, the rate of transfer of the major component across the filtration medium will be variable. Accordingly, in some embodiments, the net driving pressure differential across the filtration medium (e.g., filtration medium 106 of FIG. 1 and/or any of filtration media 106A and 106B in FIG. 2) is maintained at a substantially constant value as a function of time during operation of the filtration system.

The net driving pressure differential (ΔP_{Net}) corresponds to the difference between the established pressure differential across the filtration medium (ΔP_{E}) and the osmotic pressure differential across the filtration medium (Δπ), and can be calculated as follows:

ΔP_{Net} =ΔP_{E}−Δπ=(P_{R}−P_{P})−(π_{R}−π_{P})

In certain cases, the osmotic pressure may not be uniform on the retentate side (π_{R}) or the permeate side (π_{P}) of the filter. Accordingly, for the purposes of calculating the net pressure differential, the osmotic pressure on the retentate side of the filter is calculated as the spatial average osmotic pressure at the surface of the retentate side of the filtration medium, and the osmotic pressure on the permeate side of the filter is determined as the spatial average osmotic pressure at the surface of the permeate side of the filtration medium. Such osmotic pressures can be calculated by positioning component concentration sensors at a statistically representative number of points on the retentate and permeate sides of the filtration medium.

In addition, in some cases, the gauge pressure may not be uniform on the retentate side (P_{R}) or the permeate side (P_{P}) of the filter. Accordingly, for the purposes of calculating the net pressure differential, the gauge pressure on the retentate side of the filter is calculated as the spatial average gauge pressure at the surface of the retentate side of the filtration medium, and the gauge pressure on the permeate side of the filter is determined as the spatial average gauge pressure at the surface of the permeate side of the filtration medium. Such gauge pressures can be calculated by positioning pressure sensors at a statistically representative number of points on the retentate and permeate sides of the filtration medium.

In some embodiments, during a majority of the time over which the filter is operated (e.g., over at least about 50%, at least about 70%, at least about 90%, at least about 95%, at least about 99%, or all of the time over which the filter is operated) the net driving pressure differential is maintained at a substantially constant value (i.e., within about 50%, within about 25%, within about 10%, within about 5%, within about 2%, or within about 1% of a time-averaged value during the period of time over which incoming liquid is filtered by the filter). Maintaining the net driving pressure differential at a substantially constant value may be achieved, for example, by adjusting the hydraulic pressure differential established across the filtration medium, for example, in response to a change in the concentration of one or more minor components in the permeate, in the retentate, or in the feed.

The osmotic pressure (H) of a particular liquid mixture containing n minor components is generally calculated as:

$$Π = {\sum }_{j = 1}^{n} {i}_{j} {C}_{j} RT$$

wherein is the van't Hoff factor of the j^{th} minor component, Cⱼ is the molar concentration of the j^{th} minor component, R is the ideal gas constant, and T is the absolute temperature of the mixture. For the purposes of determining the osmotic pressure of a liquid stream (e.g., a feed stream, a permeate stream, a retentate stream, etc.) the osmotic pressure is calculated by measuring average concentrations of minor components within the stream, and calculating H using the above equation. For mixtures containing a single minor component, the osmotic pressure (H) is calculated as:

π=iCRT

wherein i is the van't Hoff factor of the minor component, C is the molar concentration of the minor component, R is the ideal gas constant, and T is the absolute temperature of the mixture.

The net driving pressure differential could be controlled using methods that would be apparent to those of ordinary skill in the art, given the insights provided by the instant disclosure. For example, in some embodiments, the net driving pressure differential could be controlled by measuring the permeate flow rate and adjusting the applied hydraulic pressure to keep the permeate flow rate constant in time.

In certain embodiments, the net driving pressure differential could be controlled using an open loop pressure control scheme. For example, if one assumes reasonable rejection of solutes that contribute most to the osmotic pressure of the retentate side solution, the bulk osmotic pressure of the retentate (π_{R}) rises with time (t) as follows:

$${Π}_{R} ( t = τ ) \approx \frac{{Π}_{R} ( t = 0 )}{1 - \frac{\dot{V} \times τ}{{V}_{0}}}$$

where \dot{V} is the volume flow rate of permeate and V₀ is the initial volume on the retentate side. The flow of permeate, \dot{V}, is given by:

V≈A×Aₘ×(ΔP_{E}(t)−(π_{R}(t)×CPF))

where A is the membrane area, Aₘ is the membrane permeability, ΔP_{E} is the established hydraulic pressure difference between the retentate and permeate side, and CPF is the concentration polarization factor. The concentration polarization factor (CPF) can be determined empirically for a system by measuring the flow rate of permeate obtained using a known feed stream composition, a known established hydraulic pressure differential, retentate gauge pressure, and membrane area. The permeate osmotic pressure can be ignored to obtain a first order approximation. Solving the above equation yields an expression for the hydraulic pressure required as a function of time in terms of known quantities:

$$Δ {P}_{E} ( t ) \approx \frac{\dot{V}}{A \times {A}_{m}} + \frac{{Π}_{R} ( t ) \times CPF}{1 - \frac{\dot{V} \times t}{{V}_{0}}}$$

A variety of filters can be used in association with the embodiments described herein. In certain embodiments, the filter comprises a filtration medium. The filtration medium comprises, according to certain embodiments, any medium, material, or object having sufficient hydraulic permeability to allow at least a portion of the major component of the liquid fed to the filter to pass through the medium, while, at the same time, retaining and/or preventing passage of at least a portion of the minor component(s) of the liquid fed to the filter.

Exemplary filters that may be utilized in various of the embodiments described herein include, but are not limited to, gel permeation filters and membrane-based filters. For example, the filter can be a spiral filter, a flat sheet filter, a hollow fiber filter, a tube membrane filter, or any other type of filter.

The filters described herein can comprise any suitable filtration medium. In some embodiments, the filtration medium comprises a filtration membrane (e.g., a semipermeable membrane). The filtration medium can be fabricated from a variety of materials. For example, the filtration medium can be fabricated from inorganic materials (e.g., ceramics), organic materials (e.g., polymers), and/or composites of inorganic and organic materials (e.g., ceramic and organic polymer composites). Suitable polymeric materials from which the filtration medium may be fabricated include, but are not limited to, poly(tetrafluoroethylene), polysulfones, polyamides, polycarbonates, polyesters, polyethylene oxides, polypropylene oxides, polyvinylidene fluorides, poly(acrylates), and co-polymers and/or combinations of these. In certain embodiments, the filtration medium comprises a polyamide-based salt rejecting layer. Filtration media typically used to make seawater reverse osmosis membranes, brackish water reverse osmosis membrane, and/or or a sanitary reverse osmosis membranes can be used in certain of the embodiments described herein.

In certain embodiments, the filtration medium is in the form of a thin film membrane, for example, having a thickness of less than about 1 millimeter, less than about 500 micrometers, or less than about 250 micrometers. In some embodiments, the filtration medium is a thin-film composite membrane.

According to certain embodiments, the filtration medium can be selected to have a porosity and molecular weight cutoff that allows passage of the major component of the liquid feed through the filtration medium while retaining a sufficiently large portion of the minor component(s) that the minor component(s) (e.g., the target minor component) is concentrated on the retentate side of the filtration medium. In embodiments where the filtration medium is used to de-water a liquid feed, the filtration membrane can be selected so that it is able to freely pass water, while, at the same time, retaining, on the retentate side, a sufficient amount of the minor component(s) (e.g., the target minor component) to result in concentration of the minor component on the retentate side of the filtration medium.

According to certain embodiments, the filtration medium is a reverse osmosis membrane. The reverse osmosis membrane can have an average pore size of less than about 0.001 micrometers, in some embodiments. In certain embodiments, the reverse osmosis membrane can have a molecular weight cutoff of less than about 200 g/mol. In some embodiments, the filtration medium is a nanofiltration membrane. The nanofiltration membrane can have an average pore size of between about 0.001 micrometers and about 0.01 micrometers, in some embodiments. In certain embodiments, the nanofiltration membrane can have a molecular weight cutoff of between about 200 g/mol and about 20,000 g/mol. In certain embodiments, the filtration medium is an ultrafiltration membrane. The ultrafiltration membrane can have, according to certain embodiments, an average pore size of between about 0.01 micrometers and about 0.1 micrometers. In some embodiments, the ultrafiltration membrane has a molecular weight cutoff of between about 20,000 g/mol and about 100,000 g/mol. In some embodiments, the filtration medium is a microfiltration membrane. The microfiltration membrane can have an average pore size of between about 0.1 micrometers and about 10 micrometers, according to certain embodiments. In some embodiments, the microfiltration membrane has a molecular weight cutoff of between about 100,000 g/mol and about 5,000,000 g/mol.

According to certain embodiments, at least one (or all) of the filtration media used in the filtration system has a relatively high standard salt rejection. The standard salt rejection is a term generally known to those of ordinary skill in the art, is generally measured as a percentage, and can be determined using the following test. A 400 square foot sample of the filtration medium is assembled into a spiral wound element of 40 inches in length and 8 inches in diameter, having a retentate spacer thickness (i.e., the distance from the retentate wall to the filtration medium) of 30 mil and a permeate spacer thickness (i.e., the distance from the permeate wall to the filtration medium) of 30 mil. A feed stream containing water and dissolved NaCl at a concentration of 32,000 mg/L and a pH of 7 is fed to the retentate side of the filter. The feed is pressurized to 800 psi gauge, with the permeate side of the filter maintained at atmospheric pressure. The filter is operated at a recovery ratio (i.e., the permeate flow rate divided by the feed flow rate, multiplied by 100%) of 10% and a temperature of 25° C. The standard salt rejection is determined, after 30 minutes of operation and at steady state, using the following formula:

$${R}_{S} = \frac{{w}_{NaCl , permeate}}{{w}_{NaCl , feed}} \times 100 \%$$

wherein w_{NaCl,permeate} is the weight percentage of NaCl in the permeate and w_{NaClfeed} is the weight percentage of NaCl in the feed. According to certain embodiments, at least one (or all) of the filtration media used in the filtration system has a standard salt rejection of at least about 99%, at least about 99.5% or at least about 99.8%.

According to certain embodiments, the filter comprises a vessel within which the filtration medium is housed. In some embodiments, the vessel is configured to withstand a relatively high internal hydraulic pressure without rupturing. The ability of the filter vessel to withstand high hydraulic pressures can be advantageous in certain cases in which high hydraulic pressures are employed to achieve a desired degree of separation between the major component and the minor component(s) of the liquid fed to the filter. In some embodiments, the vessel of the filter is configured to withstand an internal pressure of at least about 3900 psi gauge without rupturing.

According to certain embodiments, the filtration systems described herein can be configured to operate at relatively high hydraulic pressures. In some embodiments, the pumps, conduits, and/or any other system components can be operated at a hydraulic pressure of at least about 400 psi without failing.

Examples of suitable filters that could be used in association with certain of the embodiments described herein include, but are not limited to, those available from Hydranautics (Oceanside, Calif.) (e.g., under part numbers ESPA2-4040, ESPA2-LD-4040, ESPA2-LD, ESPA2MAX, ESPA4MAX, ESPA3, ESPA4-LD, SanRO HS-4, SanRO HS2-8, ESNA1-LF2-LD, ESNA1-LF2-LD-4040, ESNA1-LF-LD, SWC4BMAX, SWCS-LD-4040, SWCS-LD, SWCSMAX, SWC6-4040, SWC6, SWC6MAX, ESNA1-LF2-LD, ESNA1-LF-LD, ESNA1-LF2-LD-4040, ESNA1-LF-LD-4040, HYDRAcap6O-LD, and HYDRAcap60); Dow Filmtec via Dow Chemical Company (Midland, MI) (e.g., under part numbers HSRO-390-FF, LC HR-4040, LC LE-4040, SW3OHRLE-4040, SW3OHRLE-440i, SW3OHRLE-400i, SW3OHRLE-370/34i, SW3OXHR-400i, SW3OHRLE-400, SW3OHR-380, NF90-400, NF270-400, NF90-4040); Toray Industries, Inc. (e.g., under part numbers TM720-440, TM720C-440, TM720L-440); Koch Membrane Systems, Inc. (Wilmington, Mass.) (e.g., under part numbers 8040-HR-400-34, 8040-HR-400-28); and LG NanoH₂O (El Segundo, Calif.) (e.g., under part numbers Qfx SW 400 ES, Qfx SW 400 SR, Qfx SW 400 R). In some embodiments, the filter comprises a thin film composite membrane. For example, the thin film composite membrane can comprise a non-woven fabric with a thickness of about 150 micrometers used as a mechanical support. A porous polysulfone layer (e.g., roughly 60 micrometers in thickness) can be placed upon the support layer by a phase inversion method. A polyamide layer (e.g., of roughly 200 nm) can be cast upon the polysulfone layer using interfacial polymerization.

Certain of the embodiments described herein involve controlling the concentration(s) of minor component(s) within various portions of the filtration system. Those of ordinary skill in the art, with the insight provided by the instant disclosure, would be capable of selecting suitable operating parameters and/or system components to achieve desired concentration levels using no more than routine experimentation. For example, the surface area of the filtration medium, filtration medium properties, the applied differential hydraulic pressures, flow rates, and other operating parameters can be selected according to the needs of the particular application. As one particular example, the selection of suitable operating parameters and/or equipment characteristics can be based upon the total volume of concentrate to be produced over a given period of time, the amount of incoming liquid feed that is to be concentrated over a given period of time, or other factors as apparent to those of ordinary skill in the filtration arts. In some cases, screening tests may be performed for selecting appropriate types of filter vessels and/or filtration media by performing a trial filtration of a dilute liquid feed with a particular filter until a desired degree of concentration is obtained, followed by collecting the concentrate from the retentate side of the filter, reconstituting the liquid feed with a volume of fresh major component (equal to the volume of major component removed during filtration), and comparing the taste and/or flavor characteristics of the reconstituted liquid feed to that of the initial liquid feed. Operating pressures, filter properties, flow rates, and other operating parameters may be selected on the basis of well-known principles filtration and/or separations, described in many well-known and readily available texts describing filtration/reverse osmosis, combined with routine experimentation and optimization. Appropriate hydraulic pressures and/or flow rates could be established using feedback control mechanisms (e.g., open or closed loop feedback control mechanisms) known to those of ordinary skill in the art.

In certain embodiments, liquid(s) within filter(s) can be kept at relatively cold temperatures. For example, in some embodiments, the liquid(s) within at least one filter of the filtration systems described herein can be maintained at a temperature of about 8° C. or less (e.g., between about 0° C. and about 8° C.). In some embodiments, the liquids within all filters of the filtration system are maintained at a temperature of about 8° C. or less (e.g., between about 0° C. and about 8° C.).

In certain embodiments, one or more filters may include a gaseous headspace, for example, above a liquid contained within the filter. In some such embodiments, the gaseous headspace may be filled with a gas that does not substantially react with any components of the liquid within the filter. In some such embodiments, the gaseous headspace may be filled with a gas that does not substantially react with any minor components of the liquid within the filter. In some such embodiments, the gaseous headspace may be filled with a gas that does not substantially react with the target minor component of the liquid within the filter. All or a portion of the gaseous headspace may be made up of, for example, carbon dioxide, nitrogen, and/or a noble gas. In some embodiments, all or a portion (e.g., at least about 5 wt %, at least about 25 wt %, or at least about 50 wt %) of the gaseous headspace within at least one filter (or all filters) of the filtration system is made of up carbon dioxide. In some embodiments, the gaseous headspace contains oxygen in an amount of less than about 1 part per billion.

In certain embodiments, any of the filtration systems and/or processes described herein can be operated continuously. For example, certain methods may involve the continuous flow of a liquid feed and the continuous production of one or more retentate streams (e.g., enriched in the target minor component relative to the liquid feed) and/or one or more permeate streams (e.g., enriched in the major component relative to the liquid feed). In some cases, the method may involve conducting one or more steps of the filtration process simultaneously. For example, in some embodiments, hydraulic pressure differentials may be applied across at least two (or all) of the first filter, the second filter, and/or the third filter simultaneously. In some such embodiments, a first permeate, a first retentate, a second permeate, a second retentate, a third permeate, and/or a third retentate may be produced simultaneously. In some continuous embodiments, the method may be performed at steady state.

Unless indicated to the contrary, all concentrations and relative abundances of the components described herein are determined using weight percentages.

Various of the filters, filter portions, and/or streams are described herein and/or illustrated in the figures as being optionally “directly fluidically connected” to other portions of a system (e.g., another filter or filter portion and/or another stream).

According to certain embodiments, a first location (e.g., stream or component) and a second location (e.g., stream or component) that are described or illustrated as being directly fluidically connected may be fluidically connected such that the composition of the fluid does not substantially change (i.e., no fluid component changes in relative abundance by more than 1%) as it is transported from the first object to the second object.

U.S. Provisional Patent Application Ser. No. 62/080,727, filed Nov. 17, 2014 and entitled “Minor Component Ratio Balancing in Filtration Systems, and Associated Methods,” is incorporated herein by reference in its entirety for all purposes.

The following examples are intended to illustrate certain embodiments of the present invention, but do not exemplify the full scope of the invention.

### EXAMPLE 1

This example describes the use of a filtration medium to separate ethanol from water.

A sample of a thin film composite reverse osmosis membrane measuring 4.9 cm in diameter was installed within a dead-end, stirred cell (HP4750; Sterlitech). The cell was filled with 300 mL of a 3.9+/−0.05% ABV (alcohol by volume) ethanol-in-water solution at 21 degrees Celsius. A magnetic stirrer was turned on and a pressure of 1000 psi was applied using a nitrogen cylinder connected to the cell. Permeate was collected over a period of 30 minutes. This permeate was discarded and additional permeate was collected for another 20 minutes. After this 20 minute period, a 1 mL sample was taken from the permeate that had been collected. The ethanol content of the permeate samples was determined using gas chromatography in conjunction with a mass spectrometer. Ion chromatogram results, benchmarked against a standard curve for ethanol concentration, indicated a permeate ethanol concentration of 1.76+/−0.003%, corresponding to an ethanol rejection of 55% +/−1%.

In a separate test using the same setup as described above, an aqueous feed solution containing 32,000+/-600 mg/L of NaCl as the sole solute was introduced into the cell. The conductivity of the solution was determined, at 25° C., to be 48.5+/−0.5 mS/cm. The magnetic stirrer was turned on and a pressure of 1000 psi was applied using a nitrogen cylinder connected to the cell. Permeate was collected over a period of 30 minutes. This permeate was discarded and additional permeate was collected for another 15 minutes. After this 15 minute period, the permeate conductivity was determined, at 25° C., to be 1.28+/−0.01 mS/cm. This corresponded to a salt rejection of roughly 97.5+/−1% (which may be lower than the membrane's true value due to leakage of the feed stream around the membrane into the permeate).

### EXAMPLE 2

This example describes the use of a filtration medium to concentrate beer. Using the same setup as described in Example 1, a 290+/−10 mL sample of a 4.8% ABV Hefeweizen beer was introduced into the stirred cell. Prior to introducing the beer into the cell, the cell was first purged with carbon dioxide. A cooling jacket was applied around the stirred cell to maintain the fluid at 2+/−5° C. The stirrer was turned on and a pressure of 1000 psi was applied. The test was allowed to run until a mass of permeate roughly equaling half of the initial mass of the feed liquid was produced. The first concentrate was then set aside and stored at 5° C. in a container that had been pre-purged with CO₂.

The cell was rinsed with distilled water and the first permeate was introduced into the cell. Prior to introducing the first permeate into the cell, the cell was purged with carbon dioxide. A cooling jacket was applied around the stirred cell to maintain the fluid at 2+/−5° C. Again, the stirrer was turned on and a pressure of 1000 psi was applied. The test was allowed to run until 119.7+/−0.1 g of a second permeate were produced. The fluid within the cell (the second concentrate) was mixed with the first concentrate to produce a final concentrate.

The final concentrate was then mixed with distilled water that had been force carbonated to contain 5 volumes of CO₂ at a ratio of 9:11 to produce a reconstituted beer. This level of carbonation of the distilled water was chosen to target roughly 2.5 volumes of CO₂ in the reconstituted beer. Distilled water was employed so that the reconstituted beer would best match the original beer in taste. This is important as beer drinkers place great importance on the water source from which the beer was made. By using water that is comprised of more than 99.999999% or more than 99.9999999% H₂O by weight, the reconstituted beer's taste will only be a function of the source water used in the brewing of the original beer and not of the water used to reconstitute the beer. As an alternative to distilled water, deionized water with a conductivity of less than 5 0/cm or less than 1 μS/cm or less than 0.1 μS/cm could have been employed for reconstitution. As another alternative, well water, surface water or water from a municipal supply could have been employed so long as it had first been filtered by a single pass or two passes of nano-filtration or of reverse osmosis.

The reconstituted beer was submitted to a professional tasting panel, who noted that the aroma profile was substantially maintained though the reproduced beer had suffered from oxidation—likely due to inadvertent contact with air during the process. The effects of oxidation were less prominent, however, than in previous tests where the process temperature was above 2+/−5° C.—likely because of the slower rate of oxidation at lower temperatures.

The ethanol content of samples was determined using gas chromatography in conjunction with a mass spectrometer. Ion chromatogram results, benchmarked against a standard curve for ethanol concentration, indicated that the first concentrate, the second concentrate, the final concentrate and the second permeate contained 10.94+/−0.01, 3.57+/−0.02, 8.51+/−0.04 and 0.21+/−0.002 ABV. This implies that the ethanol passage of the overall process (the ratio of ethanol concentration in the second permeate to that in the initial feed) was 4.5% and the ethanol rejection of the overall process (unity minus the ethanol passage) was 95.5%. The high level of ethanol rejection was likely due to the low temperature at which the process was run, allowing ethanol diffusion through the membrane to be slowed.

### EXAMPLE 3

This example describes how a filtration system in which the ratio of minor components within a liquid feed is maintained in the filtration product streams could be operated. Such arrangements can allow one to produce a concentrate with a flavor profile that excellently matches the initial feed—even if only a small number of filtration steps have been employed. This process can be used, for example, to simultaneously concentrate and dilute a high gravity beer to produce a final low gravity product along with a concentrate for bulk shipping.

The filtration system can be arranged as illustrated in FIG. 2. Referring to FIG. 2, beer (containing water, ethanol, and protein) can be fed to first filter 101A, and a hydraulic pressure differential can be established across filtration medium 106A to produce first retentate 112A and first permeate 114A. Permeate stream 114A from first filter 101A can then be transported to second filter 101B, and a second retentate 112B and a second permeate 114B can be formed. If both protein and ethanol were contained within the feed to the first filter, then the retentate from the first filter will typically have a lower ratio of ethanol to protein than the feed stream, since protein is typically better rejected by membranes than ethanol. Permeate 114A from first filter 101A will consist primarily of water and ethanol, since the protein within feed 108 will be almost entirely diverted to retentate stream 112A. Ultimately, stream 112A has a high concentration of proteins and ethanol while stream 114A contains largely water and ethanol.

If retentate streams 112A and 112B are mixed without diverting any of stream 112A away via stream 201, the ethanol to protein ratio within the mixed retentate stream will be below that of the initial beer, since a portion of the ethanol will have been lost to permeate stream 114B. If, however, only a portion (x) of retentate stream 112A is mixed with retentate stream 112B (via stream 202), and the remaining portion (1-x) of stream 112A is combined with permeate stream 114B from second filter 112B (via stream 201), the protein-to-ethanol ratio within streams 203 and 204 can be relatively close to each other and the protein-to-ethanol ratio of initial feed 108.

As one specific example, one may consider the concentration of a high gravity beer (i.e., a beer that is brewed at high concentration and subsequently diluted to the desired, consumable concentration) with an initial ethanol concentration of 8% by weight and protein content of 0.8% by weight. The filtration system in FIG. 2 can be used to produce a concentrate (in stream 204) with the same or similar ethanol-to-protein ratio as the initial beer (in stream 108) as well as a diluted final product (in stream 203) for immediate consumption, also with the same ethanol-to-protein ratio.

Table 1 shows the mass flow rates (\dot{m}, in kg/s) and concentrations (C_{E} for ethanol and C_{S} for protein, in weight percent) of the streams in FIG. 2 for a representative process where the ethanol rejection, protein rejection and water recovery ratio are 60%, 99% and 50%, respectively, in each of the two filtration steps.

TABLE 1
Mass flow rates, ethanol and protein concentrations
of the streams in exemplary filtration process

| Stream | \dot{m} (kg/s) | C_{E} (wt %) | C_{S} (wt %) |
|---|---|---|---|
| 108 | 1 | 8.0% | 0.8% |
| 112A | 0.5 | 12.8% | 1.592% |
| 114A | 0.5 | 3.2% | 0.008% |
| 112B | 0.25 | 5.12% | 0.01592% |
| 114B | 0.25 | 1.28% | 0.00008% |

The ethanol-to-protein ratio of the initial high gravity beer is 10. If none of stream 112A is blended with stream 114B (i.e., if x=1 in the description above), the concentration of ethanol in stream 204 would be 10.24 wt %, and the concentration of protein in stream 204 would be 1.066 wt %, leading to an ethanol-to-protein ratio in final retentate stream 204 of 9.6. In addition, if none of stream 112A is blended with stream 114B, the concentration of ethanol in stream 203 would be 1.28 wt %, and the concentration of protein in stream 203 would be 0.00008 wt %, leading to an ethanol-to-protein ratio in final permeate stream 203 of 16000.

By contrast, if 20.5 wt % of stream 112A is blended with stream 114B (and only 79.5 wt % of stream 112A is blended with stream 112B) then the concentration of ethanol in stream 204 would be 9.835 wt %, and the concentration of protein in stream 204 would be 0.9835 wt %, leading to an ethanol-to-protein ratio in final retentate stream 204 of 10. In addition, if 30 wt % of stream 112A is blended with stream 114B, the concentration of ethanol in stream 203 would be 4.63 wt %, and the concentration of protein in stream 203 would be 0.463 wt %, leading to an ethanol-to-protein ratio in final permeate stream 203 of 10.

This tailored concentration process is thus an example in which a high gravity beer can be processed to produce a high concentration retentate stream 204 (e.g., for shipping) as well as a lower-concentration permeate stream 203 that has the desirable beer composition and is ready for consumption.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A method of concentrating a minor component of a liquid feed, comprising:
establishing a hydraulic pressure differential across a filtration medium within a first filter receiving a liquid feed comprising a major component and the minor component to produce a first permeate enriched in the major component relative to the liquid feed and a first retentate enriched in the minor component relative to the liquid feed;
establishing a hydraulic pressure differential across a filtration medium within a second filter receiving at least a portion of the first permeate to produce a second permeate enriched in the major component relative to the first permeate and a second retentate enriched in the minor component relative to the first permeate;
mixing a first portion of the first retentate with at least a portion of the second permeate; and
mixing a second portion of the first retentate with at least a portion of the second retentate.

2. The method of claim 1, wherein:
mixing the first portion of the first retentate with at least a portion of the second permeate produces a first mixture;
mixing a second portion of the first retentate with at least a portion of the second retentate produces a second mixture;
the liquid feed comprises a second minor component; and
the difference between the ratio of the weight percentage of the first minor component to the weight percentage of the second minor component within the first mixture and the ratio of the weight percentage of the first minor component to the weight percentage of the second minor component within the second mixture is less than about 20%.

3. The method of claim 1, wherein:
mixing the first portion of the first retentate with at least a portion of the second permeate produces a first mixture;
the liquid feed comprises a second minor component; and
the difference between the ratio of the weight percentage of the first minor component to the weight percentage of the second minor component within the first mixture and the ratio of the weight percentage of the first minor component to the weight percentage of the second minor component within the liquid feed is less than about 20%.

4. The method of claim 1, wherein:
mixing the second portion of the first retentate with at least a portion of the second retentate produces a second mixture;
the liquid feed comprises a second minor component; and
the difference between the ratio of the weight percentage of the first minor component to the weight percentage of the second minor component within the second mixture and the ratio of the weight percentage of the first minor component to the weight percentage of the second minor component within the liquid feed is less than about 20%.

5. The method of claim 1, wherein the difference between the ratio of the weight percentage of the first minor component to the weight percentage of the second minor component within the first retentate and the ratio of the weight percentage of the first minor component to the weight percentage of the second minor component within the second permeate is at least about 5%.

6. The method of claim 1, wherein:
the liquid feed comprises a second minor component;
the first filtration medium has a first rejection percentage, by weight, with respect to the first minor component;
the first filtration medium has a second rejection percentage, by weight, with respect to the second minor component; and
the smaller of the first rejection percentage and the second rejection percentage is less than about 0.95 of the larger of the first rejection percentage and the second rejection percentage.

7. The method of any one of claim 1, wherein the major component is non-ionic and has a molecular weight of less than about 150 g/mol.

8. The method of claim 7, wherein the major component is water.

9. The method of claim 1, wherein the minor component is non-ionic and has a molecular weight of less than about 150 g/mol.

10. The method of claim 9, wherein the minor component is ethanol.

11. The method of claim 1, wherein the concentration of the minor component in the liquid feed is at least about 0.001% by weight.

12. The method of claim 1, wherein the concentration of the minor component in the liquid feed is at least about 0.01% by weight.

13. The method of claim 1, wherein the concentration of the minor component in the liquid feed is at least about 0.1% by weight.

14. The method of claim 1, wherein the concentration of the minor component in the liquid feed is at least about 1% by weight.

15. The method of claim 1, wherein the first filter and the second filter are directly fluidically connected.

16. The method of claim 1, wherein the filtration medium of at least one of the first filter and the second filter comprises a filtration membrane.

17. The method of claim 16, wherein the filtration membrane comprises a reverse osmosis membrane.

18. The method of claim 16, wherein the filtration membrane comprises a nanofiltration membrane.

19. The method of claim 16, wherein the filtration membrane comprises an ultrafiltration membrane.

20. A filtration system, comprising:
a first filter comprising a first filtration medium defining a permeate side and a retentate side of the first filter;
a second filter comprising a second filtration medium defining a permeate side and a retentate side of the second filter;
a fluidic pathway connecting the permeate side of the first filter to the retentate side of the second filter;
a fluidic pathway connecting the retentate side of the first filter to the retentate side of the second filter; and
a fluidic pathway connecting the retentate side of the first filter to the permeate side of the second filter.

21-25. (canceled)
